(19) United States
(12) Patent Application Publication
(10) Pub. No.: US 2022/0113447 A1
(43) Pub. Date: Apr. 14, 2022

(54) SYSTEMS AND METHODS FOR SELECTING HYDRAULIC FRACTURING PROCESSES

(71) Applicant: Saudi Arabian Oil Company, Dhahran (SA)

(72) Inventors: Kaiming Xia, Dhahran (SA); Tariq Mahmood, Dhahran (SA)

(73) Assignee: Saudi Arabian Oil Company, Dhahran (SA)

(21) Appl. No.: 17/070,056

(22) Filed: Oct. 14, 2020

(51) Int. Cl. G01V 99/00; E21B 43/26; G06F 30/23

(52) U.S. Cl. CPC G01V 99/005; E21B 43/26; E21B 49/00; E21B 2200/20; G06F 30/23

(57) ABSTRACT

Systems and methods for selecting a hydraulic fracturing method are disclosed. In one embodiment, a method of selecting a hydraulic fracturing process includes simulating, using one or more processors, a cased hole/perforation hydraulic fracturing process for a well within a field, wherein the simulating accounts for an interaction between hydraulic fractures and a natural fracture network surrounding the well. The method further includes receiving a determination of whether the hydraulic fractures interact with the natural fracture network according to an interaction criteria, receiving a selection of the cased hole hydraulic fracturing process in response to the hydraulic fractures not interacting with the natural fracture network according to the interaction criteria, and receiving a selection of an open hole hydraulic fracturing process in response to the hydraulic fractures interacting with the natural fracture network according to the interaction criteria.

### BACKGROUND

Hydraulic fracturing treatment in deep and tight gas reservoirs may be very challenging. The landing depth of the horizontal section of the well can reach up to a true vertical depth 4,900 meters in sandstone formation in some locations. Therefore, the vertical stress and horizontal stresses may be approximately 40% higher than shale gas/oil reservoirs in other regions. Also, the rock is very tight with very high compressive strength in such deep sandstone locations. Directly applying hydraulic fracturing tools and procedures used for shale oil/gas reservoirs at depth less than 3000 m in vertical depth may not be effective and frequently fail to breakdown surrounding rock to create fractures for a deep and tight reservoir.

Thus, alternative methods of selecting a hydraulic fracturing process in deep and tight gas reservoirs may be desired.

### SUMMARY

According to one embodiment, a method of selecting a hydraulic fracturing process includes simulating, using one or more processors, a cased hole hydraulic fracturing process for a well within a field, wherein the simulating accounts for an interaction between hydraulic fractures and natural fracture network surrounding the well. The method further includes receiving a determination of whether the hydraulic fractures interact with the natural fracture network according to an interaction criteria, receiving a selection of the cased hole/perforation hydraulic fracturing process in response to the hydraulic fractures not interacting with the natural fracture network according to the interaction criteria, and receiving a selection of an open hole hydraulic fracturing process in response to the hydraulic fractures interacting with the natural fracture network according to the interaction criteria.

According to another embodiment, a system for selecting a well completion process includes one or more processors and one or more memory modules including non-transitory computer-readable medium storing instructions. When executed by the one or more processors, the instructions cause the one or more processors to simulate a cased hole hydraulic fracturing process for a well within a field by accounting for an interaction between hydraulic fractures and a natural fracture network surrounding the well. The instructions further cause the one or more processors to receive a determination of whether the hydraulic fractures interact with the natural fracture network according to an interaction criteria, receive a selection of the cased hole/perforation hydraulic fracturing process in response to the hydraulic fractures not interacting with the natural fracture network according to the interaction criteria, and receive a selection of an open hole hydraulic fracturing process in response to the hydraulic fractures interacting with the natural fracture network according to the interaction criteria.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE DRAWINGS

FIG. 1 schematically illustrates an example cased hole/perforation hydraulic fracturing process according to one or more embodiments described and illustrated herein;

FIG. 2 schematically illustrates an example open hole hydraulic fracturing process according to one or more embodiments described and illustrated herein;

FIG. 3 graphically illustrates an example method of selecting a hydraulic fracturing process according to one or more embodiments described and illustrated herein;

FIG. 4 graphically illustrates another example method of selecting a hydraulic fracturing process according to one or more embodiments described and illustrated herein;

FIG. 5 graphically illustrates an output of a hydraulic fracturing simulation showing low hydraulic fracture and natural fracture network interaction according to one or more embodiments described and illustrated herein;

FIG. 6 graphically illustrates an output of a hydraulic fracturing simulation showing high hydraulic fracture and natural fracture network interaction according to one or more embodiments described and illustrated herein;

FIG. 7 graphically illustrates an output of a hydraulic fracturing simulation showing high hydraulic fracture and natural fracture network interaction according to one or more embodiments described and illustrated herein; and

FIG. 8 schematically illustrates an example computing device for selecting a hydraulic fracturing process according to one or more embodiments described and illustrated herein.

### DETAILED DESCRIPTION OF THE DISCLOSURE

Embodiments of the present disclosure are directed to systems and methods for selecting a well hydraulic fracturing method for horizontal wells. More particularly, embodiments provide a robust workflow which can effectively identify the right stimulation method for stimulating deep and tight gas reservoirs.

Hydraulic fracturing is a technology for facilitating economic recovery of natural gas/oil from tight formations. Hydraulic fracturing treatments are designed to stimulate production from tight reservoirs with low permeability. This often involves pumping large amounts of fluid and proppants according to the pumping schedule and thus creating long propped fractures, which have high permeability flow channels towards the wellbore and a large drainage area towards the low permeability tight formation. However, the hydraulic fracturing treatments only succeed when they are designed based on the specific character of target formations to optimize development of a complex network of hydraulic fractures and natural fractures. For some gas reservoir located at very deep and tight formation more than 4,900 meters in vertical depth, the conventional cased-hole/perforated hydraulic fracturing process fails frequently due to the downhole pressure quickly reaching the limiting pressure of wellhead safety requirement. In other words, the formation breakdown has been a challenging issue, which leads to foregoing of the hydraulic fracturing treatment. Additionally, some portions may be fractured successfully while other parts may fail. For this kind of subsurface geologic setting with high rock breakdown pressure requirement, methods for selecting the right stimulation method are desired.

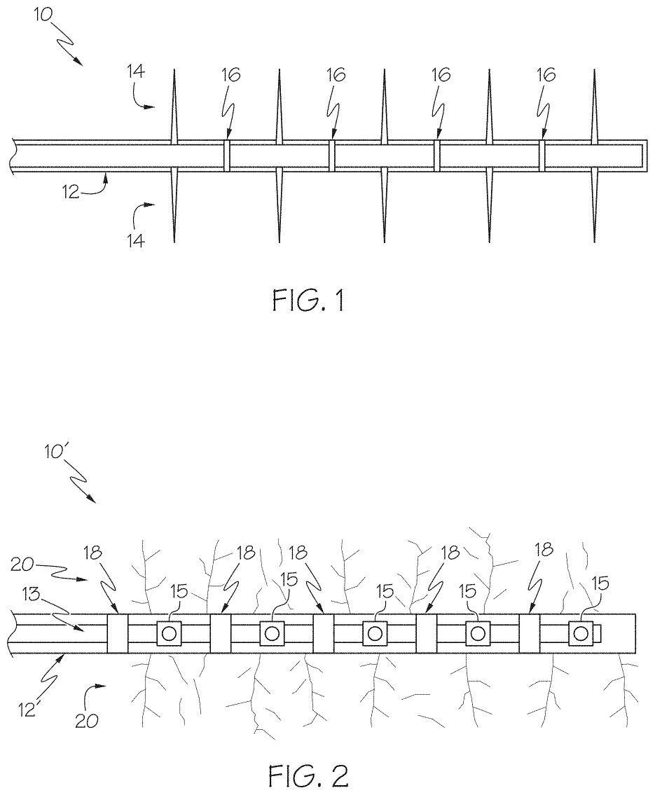

FIG. 1 schematically illustrates a cased hole hydraulic fracturing scenario 10 that includes a horizontal well 12 that is enclosed by a casing. As used herein, cased hole hydraulic fracturing also refers to perforation hydraulic fracturing. Perforations are made within a zone of the horizontal well, and high pressure fluid is pumped into the horizontal well 12 that causes the fluid to exit then the perforation, due to the high pressure fluid, and cause the surrounding rock layer to fracture into a plurality of fractures 14. A plug 16 is set prior to the recently completed zone where the process is repeated to form fractures 14 along the length of the horizontal well 12. Upon well completion after all perforations and fractures are created, the plugs 16 are removed by milling.

Cased hole hydraulic fracturing process initiates major hydraulic fractures from perforations and propagate along the maximum horizontal stress direction. For this method, the pump schedule should be well designed to guarantee that the downhole pressure around the perforation clusters is higher than the required breakdown pressure. At the same time, the surface treating pressure should be below the wellhead safety requirement. Otherwise, the hydraulic fractures cannot be initiated and treatment will fail. Currently, hydraulic fracturing simulators cannot accurately predict the required breakdown pressure due to the simplification of computer model implementation, which does not account for the 3D complex configuration of perforated wellbore (include perforation cluster and perforation phase angle). Also a large element sizes have to be used for reducing the simulation time to a practical level. Valuable time and resources may be wasted when the well completion method fails.

To prevent such hydraulic fracturing failure, an open hole hydraulic fracturing process might be a better choice. FIG. 2 illustrates an open hole scenario 10′ that includes an open horizontal well 12′. Zones of the open horizontal well 12′ are separated by isolated packers 18 that swell and provide isolation in the open horizontal well 12′. Fluid ports and fracture sleeves 15 are positioned within each zone. To fracture a zone, a furthest fluid port and fracture sleeve 15 is isolated and high pressure fluid is pumped into the open horizontal well 12′. As a non-limiting example, the fluid port and fracture sleeve 15 is isolated by a ball method wherein the ball is put into the well and seated into the fluid port and fracture sleeve 15. The high pressure fluid exits the fluid port and fracture sleeve 15 through openings and enters the surrounding rock, which causes fracturing, such as fractures 20. Backflow of the high pressure fluid is prevented by the isolated packers 18. Each zone is fractured selecting isolating the next fluid port and fracture sleeve 15.

For the open hole hydraulic fracturing process, fluid injection is aimed at initiating fracture through the weakest locations of open hole formation. However, the hydraulic pressure is relatively uniform within the isolated interval, which might not able to initiate hydraulic fractures as does the cased hole hydraulic fracturing method. Due to the large open hole interface, the injected fluid still might be able to seep into the rock formation quickly enough as planned by the pump schedule. For a reservoir with many discrete natural fractures, this method can lead to discrete natural shearing slip and significantly stimulate rock volume for successful production. Thus, the open hole hydraulic fracturing process may be an efficient method for reservoirs with many discrete natural fractures.

Generally, methods of the present disclosure comprise borehole image analysis, logging data processing, calculation of mechanical properties based on log data, poroelastic parameters and implications to fluid flow in the formation, estimation of in-situ stresses and breakdown pressure, natural fracture prediction and fracture property estimation, modeling hydraulic fracturing accounting for the interaction between hydraulic fractures and discrete natural fractures. Each of these components is weighed in the decision making process for selecting the right stimulation method for the subsurface geologic setting. Thus, hydraulic fracturing designs can be refined and modified at the field or well level to optimize the fracture network and maximize oil/gas production.

Various embodiments for selecting the appropriate hydraulic fracturing process (also referred to as a well completion process) to stimulate deep and tight reservoirs for efficient oil and gas production are described in detail herein.

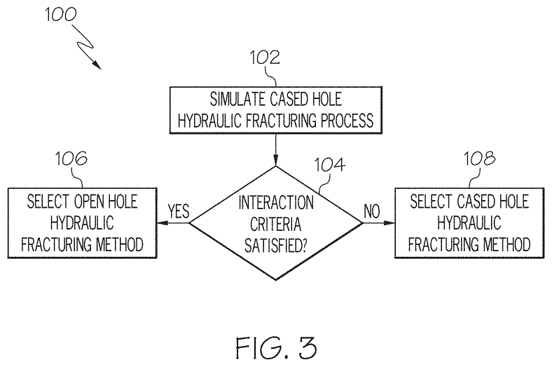

Referring now to FIG. 3, an example method 100 for selecting a hydraulic fracturing process is graphically illustrated. At block 102, a cased hole hydraulic fracturing process is simulated using any known or yet-to-be-developed simulation method. As an example, information regarding the reservoir is collected and provided to a simulation model that simulates the production of fractures, and how those fractures interact with a natural fracture network present in the vicinity of the well. The phrase “natural fracture network” means a network of natural fractures that are present within the rock surrounding the well.

The simulation model outputs an interaction between the fractures created by the simulated cased hole hydraulic fracturing process and a predicted natural fracture network. Generally, hydraulic fractures propagate along the maximum principal stress direction. In the subsurface geologic setting with well-developed natural fractures, the interaction between hydraulic fracture and natural fracture can be very complex. Several phenomena may occur during the hydraulic fracture propagating towards the natural fracture which may include: 1) hydraulic fracture arrested by natural fracture; 2) hydraulic fracture crossing natural fracture; 3) hydraulic fracture propagating along natural fractures; and 4) hydraulic fractures branching into natural fracture after crossing. Which phenomenon will happen is dependent on the natural fracture interface property, in-situ stresses, intersection angle, fluid properties, and natural fracture orientation with respect to in-situ stresses.

When fractures caused by the hydraulic fracturing process interact with the natural fracture network, they change direction from an initial direction when leaving the well to a direction of the natural fracture. Hydraulic fractures that strongly interact with natural fractures are likely to lead to a complex fracture network, which is ultimately good for production.

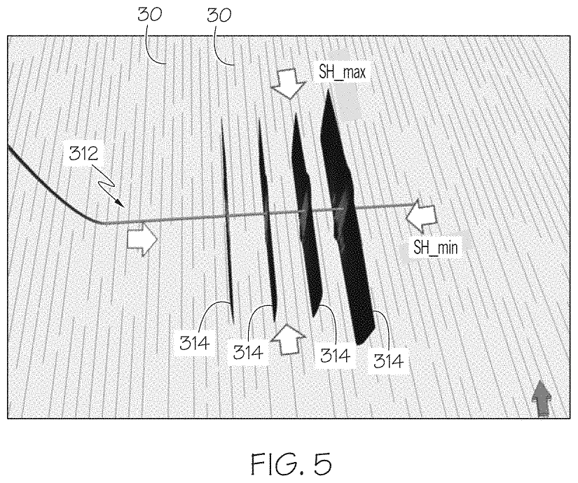

At block 104, it is determined whether or not the fractures output by the simulation model interact with a predicted natural fracture network in accordance with an interaction criteria. The interaction criteria is not limited by this disclosure. In one example, the simulation model outputs a display that illustrates the simulated fractures and predicted natural fracture network (see FIGS. 5-7 that are described in more detail below). The decision as to whether or not the simulated fractures satisfy an interaction criteria may be made heuristically by a user viewing the display. The user may apply his or her own knowledge in making the decision.

As another example, the decision at block 104 may be made deterministically by a computer. As a non-limiting example, the interaction criteria may be a threshold percentage of hydraulic fractures that change direction by more than a predetermined angle toward a direction of the natural fracture network. Embodiments are not limited by the threshold percentage. For example, without limitation, the threshold percentage may be 20%, 30%, 40%, 50%, 60%, 70%, or even 80%. Embodiments are also not limited by the predetermined angle. As non-limiting examples, the predetermined angle may be 20 degrees, 30 degrees, 40 degrees, 50 degrees, 60 degrees, 70 degrees, or 90 degrees.

The threshold percentage and/or the predetermined angle may be set by a user in a graphical user interface. As a non-limiting example, the user may set the predetermined angle at 40 degrees, and the threshold percentage at 50%. Thus, the interaction criteria is satisfied when 50% or more of the simulated fractures change direction at an angle of greater than or equal to 40 degrees in a direction parallel to the natural fracture network.

It should be understood that other interaction criterion may be used.

Referring again to FIG. 3, if the interaction criteria is satisfied (i.e., the fractures interact with the natural fracture network in accordance with the interaction criteria), the process moves to block 106 where the open hole hydraulic fracturing process is selected. In some embodiments, the user selects the open hole hydraulic fracturing process after viewing the output of the simulation on an electronic display. In other embodiments, a computer automatically selects the open hole hydraulic fracturing process and initiates scheduling to physically complete the well by the open hole hydraulic fracturing process. In either case, the well is then stimulated by any known or yet-to-be-developed open hole hydraulic fracturing process.

If the interaction criteria is not satisfied (i.e., the fractures do not interact with the natural fracture network in accordance with the interaction criteria), the process moves to block 108 where the cased hole hydraulic fracturing process is selected. In some embodiments, the user selects the cased hole hydraulic fracturing process after viewing the output of the simulation on an electronic display. In other embodiments, a computer automatically selects the cased hole/perforation hydraulic fracturing process and initiates scheduling to physically stimulate the well by the cased hole hydraulic fracturing process. In either case, the well is then stimulated by any known or yet-to-be-developed cased hole hydraulic fracturing process.

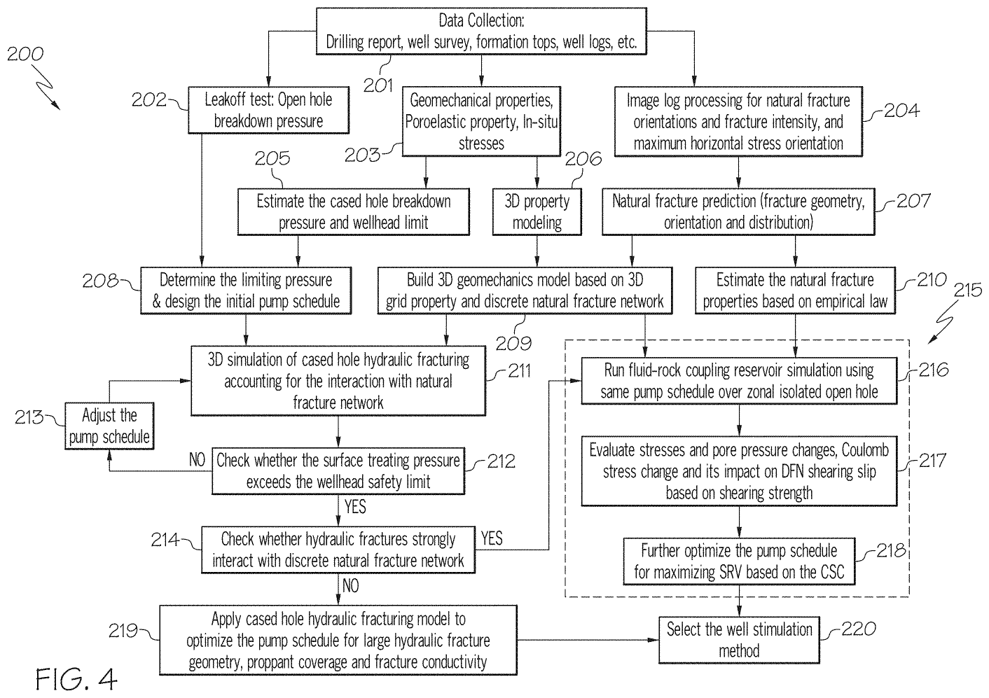

FIG. 4 illustrates another example method 200 of selecting a hydraulic fracturing process is graphically illustrated. As will be described in more detail below, the method 200 generally includes: (1) estimating rock breakdown pressure from both leak-off test and elastic theory; (2) image log processing for fracture intensity and maximum horizontal stress orientation; (3) prediction of natural fracture network (DFN) and fluid flow properties (DFN will be contained in the 3D geomechanics model for both hydraulic fracturing modeling and reservoir simulation); (4) initial pumping schedule design based on the rock breakdown pressure and wellhead/casing safety requirement; (5) applying the same pumping schedule to simulate the cased-hole/perforation hydraulic fracturing, then conducting poroelasticity-based finite element modeling of open hole fluid injection; (6) for hydraulic fracturing modeling with strong interaction between hydraulic fracture and DFN, modeling fluid injection using an open hole hydraulic fracturing process to determine the Coulomb stress change and impact on stimulated rock volume (SRV); (7) and comparing the hydraulic fracturing performance in terms of hydraulic fracture geometry and conductivity for cased hole hydraulic fracturing method, and SRV for open hole hydraulic fracturing method to determine which stimulation method should be used at the field and well scale.

At block 201, data from various sources is collected to be provided as inputs to the various models in downstream steps. Embodiments are not limited by the type of data that is collected. For example, actual, historical data may be taken in the form of drilling report, well surveys, formation tops, (e.g., sandstone, shale, carbonate), well logs (e.g., sonic logs), sensor readings, geological data, and the like.

At block 202, the breakdown pressure for open hole and cased hole/perforation hydraulic fracturing are estimated. Rock breakdown or fracture initiation may be important for a successful hydraulic fracturing process. Accurately estimating the breakdown pressure of formation may be important, which controls the selection of the correct wellhead, casing size and their burst pressure limits and initial pump schedule design. The breakdown pressure may be measured through a leak-off test. Further, the breakdown pressure may also be calculated based on elastic theory. The breakdown pressure should be estimated as accurate as possible to select the correct casing, treatment tubing, wellhead, and the like. Otherwise, the hydraulic fracturing pump schedule may not be injected as planned.

At block 203 geomechanic properties (e.g., dynamic and static Poisson's ratio, Young's modulus, shear modulus, bulk modulus, frictional angle, cohesion, tensile strength, unconfined compressive strength, bulk, Young, and shear modulus), the poroelastic property Biot's constant, and in-situ stresses of the reservoir of vertical direction σ_{V} and maximum horizontal stress σ_{Hmax}, and σ_{Hmin} are determined based on the data that is collected at block 201.

At block 204, image logs are processed to determine the natural fracture classification (e.g., bedding, stylolite, conductive and partially conductive fractures, resisting and partial resistive fractures, and induced fractures), natural fracture orientations, dip angle, fracture intensity, maximum horizontal stress orientation, and the like. The image logs may be determined in block 201 and may be compiled by providing one or more cameras or other sensors into one or more wells of the field. Any known or yet-to-be-developed method of image log processing to characterize the natural fractures may be utilized.

The output from block 204 is used to predict the natural fracture network in three-dimensional space at block 207. Based on the image log processing results, fracture data along the well trajectory may be obtained, which include fracture locations, fracture types, dip angles, dip azimuths, and the like. The fracture data is provided to a fracture modeling simulator and initial data analysis is performed first. Then, fracture data is upscaled into 3D grid. The upscaling is the process of assigning values to the cells in the 3D grid that is penetrated by the wells. Upscaling allows the well information to be used as input for the property modeling of block 206 as well.

Next, the 3D grid is populated using geostatistical methods based on the updated fracture intensity logs. For fracture modeling, the fracture intensity derived from fracture counts on image logs is limited only to the near borehole region. The fracture intensity laterally away from the wellbore may be highly uncertain. A fracture driver in the entire grid can provide additional information about the lateral/spatial extent of fractures. Generally, it works as a guide for the 3D distribution of intensity. Four types of fracture drivers can be used for fracture modeling, which are geological related information (porosity, facies, etc.), seismic (acoustic impedance), geomechanical aspect (fault related), and stress-related. Then, a fracture network model can be created using either deterministic approach or stochastic approaches. The fracture network model will be inserted into the hydraulic fracturing model later in the process. It should be understood that other methods for predicting the natural fractures may be utilized, and that embodiments are not limited by the process described above.

The cased hole hydraulic fracturing breakdown pressure is estimated at block 205 based on the geomechanical properties, the poroelastic property, and in-situ stresses determined at block 203. Any method of estimating the breakdown pressure may be used. An example method of estimating the breakdown pressure is applicable to deviated, cased hole and clustered perforation hydraulic fracturing treatment. In the model, the far field in-situ stresses are projected to the perforation coordinate system through a series intermediate coordinate system transformations. And then the projected far field in-situ stresses are superposition with the other induced stresses. The model also accounts for the effect of casing-cement intermediate layers' mechanical properties as well as the perforation quality.

At block 206, a 3D property modeling is conducted. The property modeling is the process of filling cells of the 3D grid with discrete or continuous properties. For hydraulic fracturing modeling purpose, the parameters within the 3D grid will be generated, which may include the parameters mentioned above with respect to block 203. Any known or yet-to-be-developed three-dimensional modeling technique may be utilized in generating the three-dimensional property model. As a non-limiting example, the three-dimensional model may include a three-dimensional array of cells that include values for the above-referenced properties.

A limiting pressure and an initial pump schedule is determined at block 208 from the open hole breakdown pressure and the estimated cased hole breakdown pressure and wellhead limit. The pump schedule includes attributes such as fluid injection rate, type of fluid, duration of the fluid injection, proppant type and concentration in terms of pound per gallon (ppg), and the like. The limiting pressure is the maximum pressure for casing or wellhead safety, which should be below the limiting pressure of wellhead safety. The initial pump schedule can be roughly evaluated based on the Bernoulli's equation and is optimized in blocks 209-213.

At block 209, a three-dimensional geomechanics model is generated that combines the three-dimensional model derived at block 206 with the predicted natural fracture network derived at block 207. Thus, the cells (i.e., grids) of the three-dimensional model are augmented with information regarding the natural fractures to form the three-dimensional geomechanics model.

Additionally, at block 210, the natural fracture properties of the predicted natural fracture network are estimated using empirical laws built in the fracture prediction simulator. The natural fracture properties may include natural fracture porosity, permeability, and fracture aperture.

The next step is to perform a three-dimensional simulation of a cased hole hydraulic fracturing process of a well using the initial pump schedule developed at block 208 and three-dimensional geomechanics model built at block 209. The three-dimensional simulation outputs at least a surface treating pressure (fluid pressure at the surface near wellhead), downhole pressure (fluid pressure around the perforation clusters), fracture geometry, proppant coverage, and an interaction between the simulated hydraulic fractures and the natural fracture network at provided by the three-dimensional geomechanics model derived at block 209.

The hydraulic fracturing simulator can be developed using either finite element method or boundary element method. The interaction between hydraulic fractures and natural fractures network may be dependent on the several factors. Generally, hydraulic fractures propagate along the maximum principal stress direction. In the subsurface geologic setting with well-developed natural fractures, the interaction between hydraulic fractures and natural fractures can be very complex.

Several phenomena may occur during the hydraulic fracture propagating towards the natural fracture, which may include: 1) hydraulic fracture arrested by natural fracture; 2) hydraulic fracture crossing natural fracture; 3) hydraulic fracture propagating along natural fractures; and 4) hydraulic fractures branching into natural fracture after crossing. Which phenomenon will happen is dependent on the natural fracture interface properties (frictional coefficient and cohesion), in-situ stresses, intersection angle, fluid properties, and natural fracture orientation with respect to in-situ stresses. Either of the above 3-4 scenarios may be considered an interaction between hydraulic fractures and natural fractures.

After the three-dimensional simulation is performed, at block 212 it is determined whether or not the surface treating pressure exceeds the wellhead safety limit of the well that is being simulated. If so, the process moves to block 213 where the pump schedule is adjusted and then back to block 211 for an updated three-dimensional hydraulic fracturing simulation. Blocks 211, 212, and 213 are repeated until the surface treating pressure does not exceed the wellhead safety limit of the well.

When the surface treating pressure does not exceed the wellhead safety limit at block 212, the process moves to block 214 wherein it is determined whether or not the generated hydraulic fractures interact with a natural fracture network in accordance with an interaction criteria. For example, the interaction criteria may be similar to those described at block 104 of FIG. 3.

FIG. 5 is a graphical representation of a hydraulic fracturing case outputted by the three-dimensional simulation. FIG. 5 may be displayed on an electronic display, or otherwise outputted for user review. A well 312 is provided within a reservoir including a natural fracture network defined by natural fractures 30. The natural fracture network may be predicted as described above with reference to block 207, for example. The simulation predicts several hydraulic fractures 314 as a result of the simulated cased hole hydraulic fracturing process.

In the example of FIG. 5, the natural fracture orientation aligns with the maximum principal stress direction SH_max. Because hydraulic fractures propagate along the maximum principal stress direction, the hydraulic fractures 314 of this example are parallel to the natural fractures 30 of the natural fracture network. This leads to little or no interaction between the simulated hydraulic fractures 314 and the natural fractures 30. Thus, the example of FIG. 5 illustrates the undesirable case where a complex fracture network is not formed.

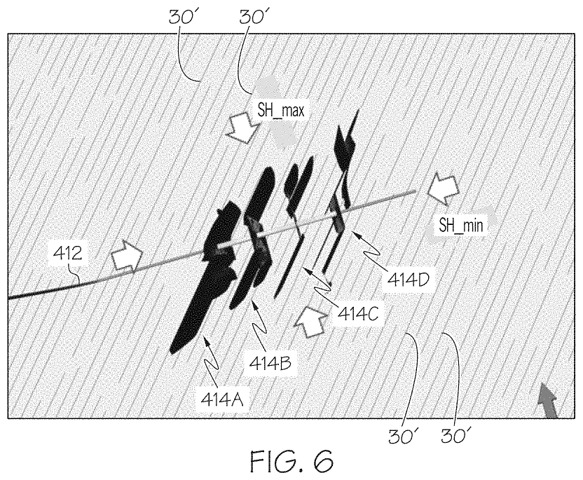

Referring now to FIG. 6, a complex fracture network case is illustrated by a graphical representation. A well 412 is provided within a reservoir including a natural fracture network defined by natural fractures 30′. The natural fracture orientation does not align with the maximum principal stress direction SH_max. Because hydraulic fractures propagate along the principal along the maximum stress direction, the hydraulic fractures 414A-414D initially propagate in a direction transverse to the orientation of the natural fractures 30′. In the illustrated example, the hydraulic fractures 414A-414D intersect the natural fractures 30′ by an intersection angle of 40 degrees. Although the hydraulic fractures 414A-414D initiate from the well 412 in the direction of maximum principal stress initially, the hydraulic fractures 414A-414D of this example change direction and propagate along the natural fractures 30′ once they reach the natural fractures 30′. Additionally, some hydraulic fractures 414A-414D may cross one or more nature fractures 30′. Thus, in this example, a complex fracture network is formed due to the strong interactions between the hydraulic fractures 414A-414D and natural fractures 30′.

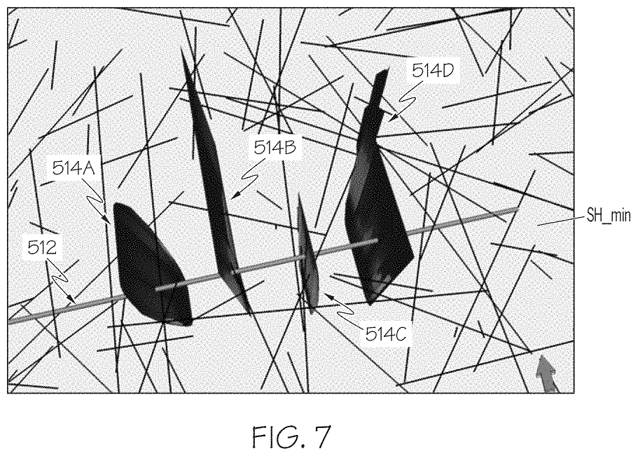

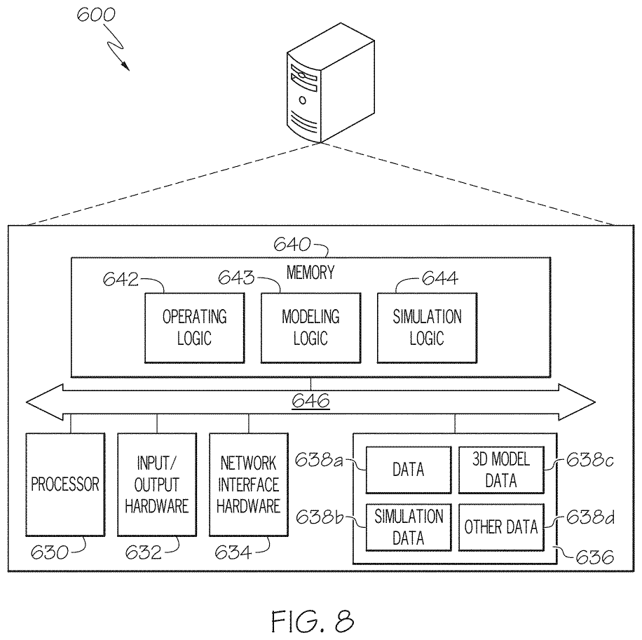

FIG. 7 illustrates another graphical representation showing an example case where a well 512 is in a reservoir having natural fractures 30″ that are in random orientations. In this case, the hydraulic fractures 514A-514D interact strongly with the natural fractures 30″ and likely lead to a complex fracture network that is good for production.

As described above, the interaction criteria may be heuristically applied by a viewer of the output. A viewer may look at the output of FIG. 5 and come to the conclusion that a majority of the hydraulic fractures 314 do not change direction due to the natural fractures 30 and thus conclude that the hydraulic fractures 314 do not strongly interact with the natural fractures 30 (i.e., the viewer's own interaction criteria is not satisfied). For the example of FIG. 5, the process would move to block 219, which is described in more detail below. Conversely, a viewer may look at the output of FIG. 6 and come to the conclusion that a majority of the hydraulic fractures 414A-414D do strongly interact with the natural fractures 30 because many change direction due to the natural fractures. Thus, in the example of FIG. 6, a complex fracture network is formed. For the example of FIG. 6, the process would move to open hole simulation process 215 described in more detail below.

The interaction criteria may be deterministic. As a non-limiting example and as stated above, the interaction criteria may be a threshold percentage of hydraulic fractures that change direction more than a predetermined angle. The predetermined angle may be any angle, and may be measured as illustrated by angle α shown in FIG. 6. Angle α is the angle between the initial segment of the hydraulic fracture and the ending segment of the hydraulic fracture.

Referring once again to FIG. 4, if at block 214 the hydraulic fractures do not interact strongly with the natural fracture network (i.e., an interaction criteria is not satisfied), the process moves to block 219 where a cased hole hydraulic fracturing model is applied to optimize the pump schedule according to one or more metrics, such as large hydraulic fracture geometry, proppant coverage, and fracture conductivity. It should be understood that in some embodiments block 219 is not performed.

After the pump schedule is optimized, the cased hole hydraulic fracturing process (i.e., a cased hole well completion method) is selected at block 220. The optimized cased hole hydraulic fracturing process may then be applied to physically hydraulically fracture the reservoir.

When there is strong interaction between the hydraulic fractures and the natural fracture network (i.e., an interaction criteria is satisfied) at block 214, an open hole hydraulic fracturing process may be more efficient and thus the process moves to the open hole simulation process 215. Thus, if strong interactions between hydraulic fractures and natural fractures can be observed, the possibility of stimulating the well through fluid injection over an open hole for each fracking stage is evaluated.

The open hole simulation process 215 receives as input the three-dimensional geomechanics model built at block 209 and the estimated natural fracture properties determined at block 210. At block 216, a fluid-rock coupling reservoir simulation is conducted using the same pump schedule over each isolated zone of the open hole well. The advantage of using fluid-rock coupling is capable of capturing the interaction between fluid flow and solid deformation within a porous rock, which is an extension of elasticity and porous medium flow (diffusion equation). The fluid-rock coupling simulation allows deformation, effective stress changes and pore pressure change to be obtained simultaneously, which are used to evaluate the natural fractures shearing slip or not. This can be achieved through finite element modeling of poroelasticity. The reservoir is defined by poroelastic material.

At block 217, evaluations of stresses and pore pressure changes, Coulomb stress change, and the impact of Coulomb stress change on the natural fracture network shearing slip are conducted. For fluid injection of hydraulic fracturing, the impact on natural fracture shearing slip can be activated during two phases. In phase 1, the hydraulic fracture openings driven by fluid injection immediately generate additional stresses at the natural fracture network. After phase 1, the pore pressure increases due to undrained response at the natural fracture network gradually develops. The fluid pressure change permeating in the formation is governed by the diffusion equation, which is dependent on the following rock properties: hydraulic diffusivity, formation permeability, fluid viscosity and storage coefficient—a function of the compressibility of both the fluid and porous rock, and distance between injection point and individual natural fracture. For either of these two phases, natural fracture shearing slip is likely to happen if the induced shear stress is high enough to exceed the breaking strength. For a production zone full of natural fractures, it is desirable to stimulate those natural fractures as much as possible. To achieve this, fluid injection over the open hole stage after stage might be a better way. The impact of this stimulation method on stimulated rock volume can be estimated through Coulomb strength theory and Coulomb stress change.

Natural fractures need stresses and pore pressure changes to trigger shearing slip, which can be activated if the shear stresses acting on the fracture surfaces overcome the resistance to slip of the adjacent rock blocks. Pore pressure change due to fluid injection can be the main reason. The shear resistance is due to friction, which is proportional to the difference between the normal stress acting on the fault, and fluid pressure in the fault. The fault is in stable state as long as the magnitude of shear stress is lower than the shear resistance or frictional strength. The critical condition is called by the Coulomb strength criterion, which reflects two fundamental factors: friction and effective stress by:

τ=μ(σₙ−p).

The presence of effective stress in the Coulomb criterion shows that the fluid pressure counterbalances the effect of the normal compression stress σₙ. The Coulomb criterion indicates that fault slip can be triggered by either decrease of the normal stress or an increase of the pore pressure, and or an increase of the shear stress. Coulomb stress change (ΔCSC) can also be used to evaluate a natural fracture becoming stable or unstable due to change of pore pressure and stress, which is given by:

ΔCSC=ΔT−μ(Δσₙ−Δp),

where Δτ is the shear stress change on a fracture in the fracture direction (positive in the direction of fracture slip), Δσₙ represents the compressive stress change that clamps or unclamps the fracture (positive if the fracture is in compression), Δp is the pore pressure change in the fracture that unclamps the fracture, and μ is the frictional coefficient of fracture surface. Based on the definition of ΔCSC, a positive change of ΔCSC promotes shearing slip and a negative change inhibits fracture shearing slip. Therefore the focal point of evaluating natural fracture shearing slip is on predicting stress and pore pressure change.

The main objective of injecting fluid through an isolated open hole is targeted at maximizing the SRV through shearing the natural fractures, and thereafter increase the permeability of the production zone. However, including all the natural fractures in the modeling is very challenging and computationally very expensive. As mentioned above the shearing slip possibility of complex natural fracture networks may be evaluated through calculating the Coulomb stress change, which uses the normal stress and pore pressure changes with respect to the natural fractures orientations induced by fluid injection of pump schedule. After finite element modeling of poroelasticity and projecting the stresses onto the fracture direction, the Coulomb stress change is calculated using the above equation and the natural fracture shearing slip is evaluated. Based on the affected areas of fracture shearing slip, the SRV can be approximately calculated. Thus, it is checked at block 217 whether natural fractures can be activated.

The main objective of this stimulation method is to drive numerous natural fractures to shear slip and therefore increase the formation permeability for good production.

Finally, at block 220 the right well hydraulic fracturing process is selected. This selection workflow is aimed at selecting the right well completion method, which can alleviate the breakdown issue for deep and tight oil/gas reservoirs and make the well stimulation more likely to be completed so that a better production can be achieved. A comparison between the two methods can be achieved through reservoir production simulations.

Embodiments of the present disclosure may be implemented by a computing device, and may be embodied as computer-readable instructions stored on a non-transitory memory device. FIG. 8 depicts an example computing device 600 configured to perform the functionalities described herein. The example computing device 600 provides a system for selecting a hydraulic fracturing process, and/or a non-transitory computer usable medium having computer readable program code for selecting a hydraulic fracturing process embodied as hardware, software, and/or firmware, according to embodiments shown and described herein. While in some embodiments, the computing device 600 may be configured as a general purpose computer with the requisite hardware, software, and/or firmware, in some embodiments, the computing device 600 may be configured as a special purpose computer designed specifically for performing the functionality described herein. It should be understood that the software, hardware, and/or firmware components depicted in FIG. 8 may also be provided in other computing devices external to the computing device 600 (e.g., data storage devices, remote server computing devices, and the like).

As also illustrated in FIG. 8, the computing device 600 (or other additional computing devices) may include a processor 630, input/output hardware 632, network interface hardware 634, a data storage component 636 (which may include data 638A (e.g., drilling report data, well survey data, formation tops data, well logs, sensor data), simulation data 638B (i.e., data relating to hydraulic fracturing simulations), three-dimensional modeling data 638C (i.e., data for modeling reservoirs), and any other data 638D for performing the functionalities described herein), and a non-transitory memory component 640. The memory component 640 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 640 may be configured to store operating logic 642, modeling logic 643 for modeling reservoirs, and simulation logic 644 for simulating hydraulic fracturing as described herein (each of which may be embodied as computer readable program code, firmware, or hardware, as an example). A local interface 646 is also included in FIG. 8 and may be implemented as a bus or other interface to facilitate communication among the components of the computing device 600.

The processor 630 may include any processing component configured to receive and execute computer readable code instructions (such as from the data storage component 636 and/or memory component 640). The input/output hardware 632 may include a graphics display device, keyboard, mouse, printer, camera, microphone, speaker, touch-screen, and/or other device for receiving, sending, and/or presenting data. The network interface hardware 634 may include any wired or wireless networking hardware, such as a modem, LAN port, wireless fidelity (Wi-Fi) card, WiMax card, mobile communications hardware, and/or other hardware for communicating with other networks and/or devices, such as to receive the data 638A from various sources, for example.

It should be understood that the data storage component 636 may reside local to and/or remote from the computing device 600, and may be configured to store one or more pieces of data for access by the computing device 600 and/or other components. As illustrated in FIG. 8, the data storage component 636 may data 638A, which in at least one embodiment includes historical data such as drilling report data, well survey report data, formation tops data, well data, and the like. The data 638A may be stored in one or more data storage devices. Similarly, simulation data 638B and the three-dimensional modeling data 638C may be stored by the data storage component 636 and may include information relating to simulating hydraulic fracturing and three-dimensional modeling of reservoirs. In another embodiment, the computing device 600 may be coupled to a remote server or other data storage device that stores the relevant data. Other data to perform the functionalities described herein may also be stored in the data storage component 636.

Included in the memory component 640 may be the operating logic 642, the modeling logic 643, and the simulation logic 644. The operating logic 642 may include an operating system and/or other software for managing components of the computing device 600. The operating logic 642 may also include computer readable program code for displaying the graphical user interface used by the user to input parameters and review results of the simulations. Similarly, the modeling logic 643 may reside in the memory component 640 and may be configured to facilitate generation models of reservoirs of interest. The simulation logic 644 may be configured to run the simulations described herein to generate the displays of the interactions between hydraulic fractures and natural fracture networks.

The components illustrated in FIG. 8 are merely exemplary and are not intended to limit the scope of this disclosure. More specifically, while the components in FIG. 8 are illustrated as residing within the computing device 600, this is a non-limiting example. In some embodiments, one or more of the components may reside external to the computing device 600.

It should now be understood that embodiments of the present disclosure are directed to systems and methods for selecting a hydraulic fracturing process for reservoirs, such as, without limitation, deep and tight gas reservoirs. More particularly, embodiments are directed to workflows for selecting the efficient and reliable well stimulation method for gas reservoirs in deep and tight formations. The workflows include, but are not limited to, borehole image analysis, logging data processing, calculation of mechanical properties based on log data, estimation of in-situ stresses and breakdown pressure, natural fracture prediction and fracture property estimation, modeling hydraulic fracturing accounting for the interaction between hydraulic fractures and discrete natural fractures. Further, the workflows include finite element modeling of fluid injection over open hole of each fracking stage, Coulomb stress change and impact on natural fracture shearing slip, and estimation of stimulated rock volume, which represents a new way to evaluate the fluid injection over the isolated open hole stimulation method. Embodiments may be weighed in selecting either cased hole hydraulic fracturing or open hole perforation hydraulic fracturing process

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A method of selecting a hydraulic fracturing process, the method comprising:
simulating, using one or more processors, a cased hole hydraulic fracturing process for a well within a field, wherein the simulating accounts for an interaction between hydraulic fractures that are created from hydraulic pressure and a natural fracture network surrounding the well;
receiving a determination of whether the hydraulic fractures of the simulation interact with the natural fracture network according to an interaction criteria;
receiving a selection of the cased hole hydraulic fracturing process in response to the hydraulic fractures not interacting with the natural fracture network according to the interaction criteria; and
receiving a selection of an open hole hydraulic fracturing process in response to the hydraulic fractures interacting with the natural fracture network according to the interaction criteria.

2. The method of claim 1, further comprising displaying, on an electronic display, a graphical representation of the interaction between the hydraulic fractures and the natural fracture network based on the simulating of the cased hole hydraulic fracturing process for the well, wherein the receiving of the determination of whether the hydraulic fractures interact with the natural fracture network according to the interaction criteria is received from a user based on the graphical representation.

3. The method of claim 1, further comprising determining a percentage of the hydraulic fractures that change direction due to the natural fracture network, wherein the interaction criteria is a threshold percentage such that when the percentage of the hydraulic fractures that change direction due to the natural fracture network is greater than or equal to the threshold percentage the hydraulic fractures interact with the natural fracture network according to the interaction criteria.

4. The method of claim 1, further comprising simulating the open hole hydraulic fracturing process for the well when the hydraulic fractures do interact with the natural fracture network according to the interaction criteria, wherein the simulating accounts for an interaction between open hole hydraulic fractures and the natural fracture network surrounding the well.

5. The method of claim 4, wherein simulating the cased hole hydraulic fracturing process comprises applying an initial pump schedule, and simulating the open hole hydraulic fracturing process comprises applying the initial pump schedule over the open hole.

6. The method of claim 5, further comprising determining a stimulated rock volume, and adjusting the initial pump schedule to increase the stimulated rock volume.

7. The method of claim 5, further comprising optimizing the initial pump schedule for the cased hole hydraulic fracturing process to provide one or more of the following: increased a hydraulic fracture geometry, increased proppant coverage, and increased fracture conductivity as compared with the initial pump schedule.

8. The method of claim 1, further comprising, prior to receiving the determination of whether the hydraulic fractures interact with the natural fracture network satisfy an interaction criteria, determining if a surface treating pressure exceeds a wellhead safety limit, and adjusting an initial pump schedule when the surface treating pressure exceeds the wellhead safety limit.

9. The method of claim 1, further comprising predicting the natural fracture network based on image log data.

10. The method of claim 1, wherein the simulating of the cased hole hydraulic fracturing process applies a three-dimensional geomechanics model that includes data regarding the natural fracture network.

11. A system for selecting a well completion process comprising:
one or more processors; and
one or more memory modules comprising non-transitory computer-readable medium storing instructions that, when executed by the one or more processors, cause the one or more processors to:
simulate a cased hole hydraulic fracturing process for a well within a field by accounting for an interaction between hydraulic fractures that are created from hydraulic pressure and a natural fracture network surrounding the well;
receive a determination of whether the hydraulic fractures of the simulation interact with the natural fracture network according to an interaction criteria;
receive a selection of the cased hole hydraulic fracturing process in response to the hydraulic fractures not interacting with the natural fracture network according to the interaction criteria; and
receive a selection of an open hole hydraulic fracturing process in response to the hydraulic fractures interacting with the natural fracture network according to the interaction criteria.

12. The system of claim 11, further comprising a display, wherein the computer-readable instructions further cause the one or more processors to display, on the electronic display, a graphical representation of the interaction between the hydraulic fractures and the natural fracture network based on the simulating of the cased hole hydraulic fracturing process for the well, wherein the receiving of the determination of whether the hydraulic fractures interact with the natural fracture network according to the interaction criteria is received from a user based on the graphical representation.

13. The system of claim 11, wherein the computer-readable instructions further cause the one or more processors to determine a percentage of the hydraulic fractures that change direction due to the natural fracture network, wherein the interaction criteria is a threshold percentage such that when the percentage of the hydraulic fractures that change direction due to the natural fracture network is greater than or equal to the threshold percentage the hydraulic fractures interact with the natural fracture network according to the interaction criteria.

14. The system of claim 11, wherein the computer-readable instructions further cause the one or more processors to simulate the open hole hydraulic fracturing process for the well when the hydraulic fractures interact with the natural fracture network according to the interaction criteria, wherein the simulation accounts for an interaction between open hole hydraulic fractures and the natural fracture network surrounding the well.

15. The system of claim 14, wherein the simulation of the cased hole hydraulic fracturing process comprises applying an initial pump schedule, and the simulation of the open hole hydraulic fracturing process comprises applying the initial pump schedule over the open hole.

16. The system of claim 15, wherein the computer-readable instructions further cause the one or more processors to determine a stimulated rock volume, and adjust the initial pump schedule to increase the stimulated rock volume.

17. The system of claim 15, wherein the computer-readable instructions further cause the one or more processors to optimize the initial pump schedule for the cased hole hydraulic fracturing process to provide one or more of the following: increased a hydraulic fracture geometry, increased proppant coverage, and increased fracture conductivity as compared with the initial pump schedule.

18. The system of claim 11, wherein the computer-readable instructions further cause the one or more processors to, prior to receiving the determination of whether the hydraulic fractures interact with the natural fracture network satisfy an interaction criteria, determine if a surface treating pressure exceeds a wellhead safety limit, and adjust an initial pump schedule when the surface treating pressure exceeds the wellhead safety limit.

19. The system of claim 11, wherein the computer-readable instructions further cause the one or more processors to predict the natural fracture network based on image log data.

20. The system of claim 11, wherein the simulating of the cased hole hydraulic fracturing process applies a three-dimensional geomechanics model that includes data regarding the natural fracture network.
